(19) United States
(12) Patent Application Publication
(10) Pub. No.: US 2018/0163992 A1
(43) Pub. Date: Jun. 14, 2018

(54) ADAPTER SYSTEM AND ELECTRIC HEATERS FOR INSERTION INTO WATER TANKS

(71) Applicants: Barry Lynn Butler, Solana Beach, CA (US); Roger Lee Davenport, Oceanside, CA (US); Brett Louis Butler, Encinitas, CA (US)

(72) Inventors: Barry Lynn Butler, Solana Beach, CA (US); Roger Lee Davenport, Oceanside, CA (US); Brett Louis Butler, Encinitas, CA (US)

(21) Appl. No.: 15/377,888

(22) Filed: Dec. 13, 2016

(51) Int. Cl. F24H 9/18; H05B 3/82

(52) U.S. Cl. CPC F24H 9/1818; H05B 3/06; H05B 3/82

(57) ABSTRACT

A plumbing adapter is proposed to allow electric heating elements to be placed into the ports of an existing pressurized hot water tank. The adapter allows the heating element to be inserted into either male or female tank plumbing fittings without rotation, so it allows the use of bent or shaped heating elements. This allows a heating element to be placed near the bottom of the tank and in an inclined or near-horizontal position to improve convective heat transfer. The adapter allows electric heating elements driven by photovoltaic panels or grid power to be placed into existing or new water tanks that are heated by propane, natural gas, or electric power.

### BACKGROUND OF INVENTION

Heating water uses either fossil fuels, electricity (often from fossil fuels), or solar and solar thermal systems. Many homes have gas or propane water heaters, which represent in-home sources of air-polluting greenhouse gases. Solar electricity creates less air pollution than burning fossil fuels. However, getting solar electricity from the roof top or green grid into the large stock of existing gas and propane hot water tanks which are already in people's homes is a difficult task. Heating elements that are coaxial with the water tank top fittings can be screwed into the tanks as recited by Butler et.al. and Grossman et.al. The problem is that the heater element rotates with the fitting being screwed in. Hence the heater must be nearly straight, and the heater may hit obstructions inside of the tank. These obstructions include the central flue of gas-heated tanks, the tank walls, and tank thermostats and standard electric elements. Heating elements inserted from the side ports of a tank must be very short, less than half of the tanks internal diameter, but narrow enough to fit through the port opening. To avoid the central flue the heating elements may be bent in an L-shape, but then it cannot rotate during installation into the threaded tank port, since it would hit the sides or bottom of the tank. Likewise an L-shaped heating element can be placed in a tank top port but again it cannot be rotated or the heated short arm of the L near the bottom of the tank would interfere with the central flue. Only the end portion of the heater element near the bottom of the tank will be heated; the connecting tubing will contain lead wires for the heater elements. The adapter described in this application is made of standard plumbing parts and has three functions. The first is embodied in a standard plumbing Union that when loosened allows the nipple/female thread to rotate into the water tank fitting without requiring the heating element to rotate. Once the fitting is in place, the Union is tightened to form a leak-proof seal. The second function is embodied in the plumber's Tee adapter which allows water to pass in or out of the adapter by going past the heater element case and entering or exiting from the Tee's side port. The third function is that the three individual parts of the adapter can be slid over a bent heater element, then assembled into the competed adapter system. Half of the Union, the other half of the Union attached to or separate from the Tee, and finally the extension nipple which is male-to-male or male-to-female are slid over the bent heater element and then assembled together to form the completed adapter.

### SUMMARY OF INVENTION

In summary, the present invention is a family of adapters which allow bent or shaped electric water heating elements to be introduced into standard pressurized hot water tanks. The purpose of this invention is to allow electrical resistance heaters to be inserted into the standard female or male national plumbing threaded fittings found on standard pressurized water heaters. The electrical heaters can be bent to miss internal tank components such as a central flue, temperature sensors, pressure relief valves and curved tank walls. These adapters allow the resistance heaters to be placed near the bottom of the tank, so the water inside the tank can be heated by natural convection over the heating elements.

### PRIOR ART

The most common solar photovoltaic-powered hot water heaters use electric heating elements immersed in the tank through special ports only available on standard electric hot water heaters. These special ports for electric heating elements are not present on gas or propane hot water tanks. Heating elements that are coaxial with the water tank fittings can be screwed into the tanks as recited by Butler et.al. and Grossman et.al. These tank heaters are limited in length and shape by the internal structure of the tank. A plumbing fitting that does not require the heater elements to rotate with it during insertion allows many more heater configurations. The most advantageous of which is allowing the heated section of the element to be placed nearly horizontal near the bottom of the tank to be heated. This allows for enhanced convective flow of cold water over the heater to heat the tank water more uniformly. A typical electric hot water tank uses two heater elements, one near the top and one near the bottom, which can rapidly heat the water in the storage tank for use, and rapidly reheat the tank after a lot of hot water is used. Prior patents on this subject show the photovoltaic panel connected to an inverter, which takes the low photovoltaic panel voltage and converts it to 120-240 VAC. This power is then used to power conventional hot water tank heating elements. Prior patents also disclose directly connecting photovoltaic panels to single-walled and double-walled heater elements. Those systems can be adapted to gas or propane hot water tanks, but require the heater elements to be vertically aligned in the tank, resulting in much less convective stirring of the water in the tank. This makes heating of the tank less effective. Short coaxial heaters can be inserted horizontally in side ports, but although they are good convectors, their length and therefore their effectiveness is limited by internal tank structures.

The primary objective of the present invention is to adapt solar-powered or grid-powered electric heating elements to conventional gas, propane or electric water heaters through existing tank ports. Another objective is to reduce the time and complexity for retrofitting solar energy to existing hot water tanks by allowing for simple installation of the heating element into the tank with a minimum of plumbing changes. Another objective is to reduce the amount of fossil fuel burned in people's homes and businesses to make hot water. Less pollution from distributed fossil fuel burners in every home makes pollution reduction easier. The objectives and advantages of the invention may be realized and attained by means of the instrumentalities and combinations particularly pointed out in the appended claims.

### DESCRIPTION OF THE DRAWINGS

FIG. 1 is a cut-away view of the tank adapter for inserting heating elements without requiring them to rotate.

FIG. 2 is a perspective view of several ways to place the heated portion of the heating element close to the bottom of the tank.

FIG. 3 is a perspective view of heater elements in both a single sheath and in a U-shape with both wires coming out through a sealed fitting at one end.

### DETAILED DESCRIPTION OF THE PREFERRED EMBODIMENT

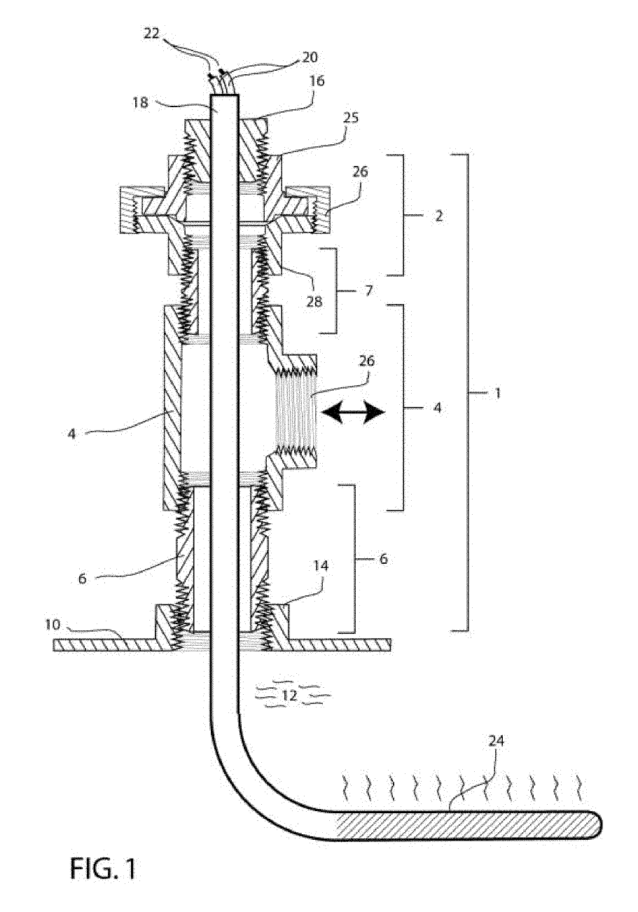

The invention consists of a pressurized hot water tank adapter that allows insertion of heating elements without requiring them to rotate, as shown in FIG. 1. The overall adapter (1) is comprised of four parts: a plumber's Union (2) consisting of: a female pipe threaded piece with a flange on the outside (28), a male threaded gland nut (26), and a female pipe thread ball nose seal piece (25); a plumbers Tee (4) connected to the Union (2) by metal joining or using a close nipple (7); and, a pipe nipple (6) that connects the other end of Tee (4) to the hot water tank port (10). The heater element sheath (18) and threaded fitting (16) is threaded into the adapter system (1). The pressurized hot water tank (10) is full of water (12) and the tank has a female pipe thread fitting (14). The pressurized hot water tank (10) can also have a male pipe thread fitting (6) welded to the tank instead of the tapped female fitting (14). Electric power comes into the heater elements in wires (22) from the power line or from photovoltaic panels. The insulated wire (20) goes into the metal heater tube (18) and connects to the resistance heater section (24) of the heater tube. The immersion heater assembly can be inserted into any existing hot water tank port (14) without impeding normal tank operation since it allows water to enter or exit the tank via the plumbing Tee (4) side port (26).

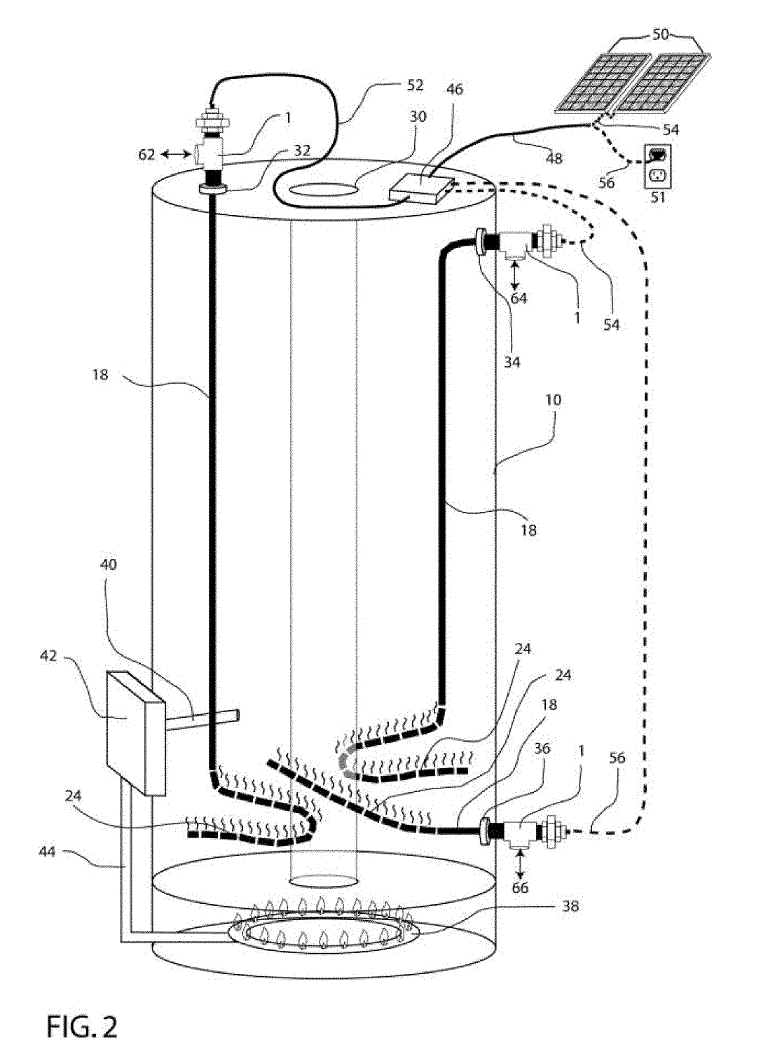

A conventional pressurized hot water tank is depicted in FIG. 2. A conventional gas hot water heater tank consists of a gas or propane burner (38) which is controlled by a gas control box (42), which senses tank water temperature (40) and turns on or off the gas flowing through tube (44) to the burner (38). The hot gases from the burner (38) travel up the center flue tube (30) giving up heat to the water in the tank. The tank walls (10), gas controller temperature sensor (40) and flue (30) all represent obstructions in the tank, which the immersion heaters must be designed to avoid. Three possible heater placements are shown in FIG. 2. The immersion heater assembly is threaded into the hot water tank (10) via any of the usable ports. There are three types of ports: top ports (32), side top ports (34), and bottom drain ports (36). The adapter assembly (1) has a side port for allowing water to enter or exit the tank (10) via a plumbing adapter (1). The top ports (32) are used for water to enter or exit the tank, and when the adapter (1) is installed the water comes out the adapter side port (62). The tank top-side port (34) is usually used for a temperature pressure relief valve, which would be relocated to the adapter (1) side port (64). The tank bottom port (36) is usually used for a tank drain valve and when the adapter (1) is installed the water drain valve is installed on the adapter (1) side port (66). In each of these three tank ports (32, 34, 36) the heated section (24) of each heater element is inserted through the open port. Then the heater lead section (18) follows into the tank (10). Then with the Union nut FIG. 1 (26) loose, the adapter (1) can be screwed into the chosen port without rotating the bent heater section (24) or heater lead section (18). Once the adapter is in place, the Union nut FIG. 1 (26) is tightened to lock the heater in place and make the water tight seal.

Once the heater is in place in one of the tank ports, the heater needs to be connected to a power source. The power source for alternating current (AC) can be electricity supplied from a photovoltaic/inverter system or the utility through a standard 120 VAC or 240 VAC outlet (51) through cable (56). The power can also come in the form of direct current (DC) from photovoltaic panels (50) on the home's roof via cable (54). The power from either cable (54) from PV (50) or cable (56) from the AC outlet (51) then comes through cable (48) via a thermostatic switch (46), which will cut off the power when the water temperature gets to the desired temperature set point. The power is shown going to the adapter (1) in tank top port (32) via power cable (52). Alternative power routings are shown from the thermostatic switch (46) to the adapter (1) in a tank top side port (34) via a dashed power cable (54), or from the thermostatic switch (46) to the adapter (1) in a tank bottom side port (36) via a dashed power cable (56).

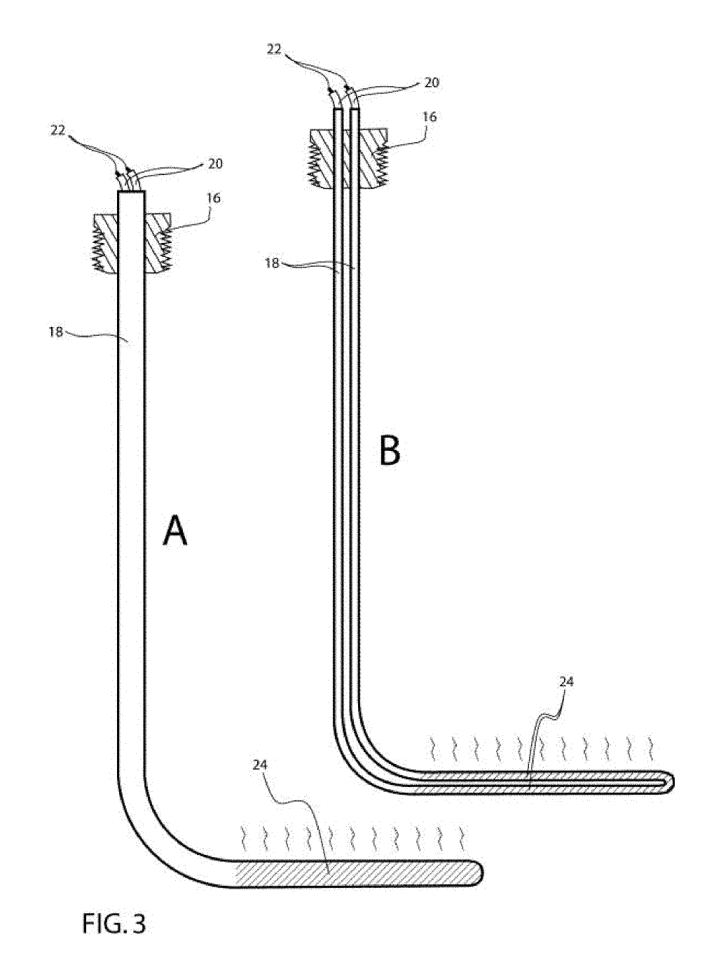

FIG. 3 shows perspective views of possible heater configurations with a single sheath (FIG. 3-A) and a U-shape (FIG. 3-B), with both wires coming out through a fitting at one end. The wires (22) from the power source are insulated with high temperature insulation (20) and go into the lead section of the heater element tube (18), then connect to the resistance heating elements in the heated section (24). FIG. 3-A shows a single heater tube where both wires are in the same sheath (18) and connect to resistance heating elements enclosed in the same sheath (24). FIG. 3-B shows a U-shaped heater tube where the wires enter at opposite ends of the tube sheath (18) and connect to resistance heating elements enclosed in the same sheath (24) near the center bend of the U-tube.

What is claimed is:

1. A hot water tank adapter that allows electric heating elements (bent, shaped, or straight) to be inserted in a pressurized hot water tank through existing ports without requiring the heater to rotate and interfere with the tanks inner walls and internal structure, comprising:
An immersion heater, comprising:
a single dosed end sheath containing electrical lead and heater sections;
a U-shaped sheath containing electrical leads and heater sections; or,
other configurations allowing the leads to exit at one end location;
A threaded plumbing fitting such that the immersion heating element is configured to be threaded to the tanks' side or top ports, comprised of:
a Union which allows one side to be rotated with respect to the other when installing and then locked in place to form a pressure seal;
a means of fastening one side of the Union to a heating element
a means of fastening one side of the Union to a plumbing Tee;
a plumbing Tee fitting to allow liquid to flow in or out past the heating element which passes through it;
a nipple to connect the Union and Tee plumbing fittings to the threaded male or female tank port:
An immersion resistance heating element where the lead and heater sections can bent while allowing the adapter fitting parts to be slid over and assembled to it, comprised of;
an electrical lead section that allows the heated section to be placed near the bottom of the water tank;
a heated section that is shaped to avoid interference with obstructions inside the tank and improve convective heat transfer.

2. A hot water tank adapter that allows electric heating elements (bent, shaped, or straight) to be inserted in a pressurized hot water tank through existing ports without requiring the heater to rotate and interfere with the tanks inner walls and internal structure, comprising:
An immersion heater, comprising:
a single closed end sheath containing electrical lead and heater sections;
a U-shaped sheath containing electrical leads and heater sections; or,
other configurations allowing the leads to exit at one end location;
A threaded plumbing fitting such that the immersion heating element is configured to be threaded to the tanks' side or top ports, comprised of:
a Union which allows one side to be rotated with respect to the other when installing and then locked in place to form a pressure seal;
a means of fastening one side of the Union to a heating element
a means of fastening one side of the Union to a threaded male or female tank port:
An immersion resistance heating element where the lead and heater sections can bent while allowing the adapter fitting parts to be slid over and assembled to it, comprised of;
an electrical lead section that allows the heated section to be placed near the bottom of the water tank;
a heated section that is shaped to avoid interference with obstructions inside the tank and improve convective heat transfer.

3. A means to allow a pressurized natural gas or propane water heater to be converted to be heated by an insertable electric heater element through an existing port, enabling either photovoltaic direct current or utility-generated or photovoltaic alternating current power to heat the water, controlled by a thermostat.

4. A heater system according to claims 1, 2 and 3 wherein the adapter is inserted through a tank top port.

5. A heater system according to claims 1 and 3 wherein the adapter is inserted through a tank top side port.

6. A heater system according to claims 1, 2 and 3 wherein the adapter is inserted through a tank bottom side port.
